(19) United States
(12) Patent Application Publication
(10) Pub. No.: US 2023/0219242 A1
(43) Pub. Date: Jul. 13, 2023

(54) ROBOT HAND, METHOD FOR CONTROLLING ROBOT HAND, ROBOT APPARATUS, METHOD FOR MANUFACTURING PRODUCT, AND RECORDING MEDIUM

(71) Applicant: CANON KABUSHIKI KAISHA, Tokyo (JP)

(72) Inventors: Kosuke Nishikawa, Saitama (JP); Shingo Amano, Kanagawa (JP)

(21) Appl. No.: 18/148,846

(22) Filed: Dec. 30, 2022

(30) Foreign Application Priority Data
Jan. 7, 2022 (JP) 2022-001524
Dec. 6, 2022 (JP) 2022-194600

(51) Int. Cl. B25J 15/10; B25J 9/16; B25J 15/00

(52) U.S. Cl. CPC B25J 15/103; B25J 9/1612; B25J 15/0038

(57) ABSTRACT

A robot hand includes at least one finger. The finger includes a first member configured to come into contact with an object to apply a gripping force to the object, and a second member movable with respect to the first member to come into contact with the object.

### BACKGROUND

### Field of the Disclosure

The present disclosure relates to technology of robot hands.

### Description of the Related Art

In recent years, in manufacturing sites such as factories, demand for a robot apparatus capable of performing multi-purpose operations has been increasing accompanied by automation of processing operations and assembly operations. Japanese Patent Laid-Open No. 2015-83323 discloses a robot hand including fingers provided with slide claws and configured to grip a part with the slide claws. In addition, Japanese Patent Laid-Open No. 2015-85481 discloses a robot hand including a finger portion configured to grip a part and a bottom plate portion provided in a hand body portion.

### SUMMARY

According to embodiments of the present disclosure, a robot hand includes at least one finger. The finger includes a first member configured to come into contact with an object to apply a gripping force to the object, and a second member movable with respect to the first member to come into contact with the object.

According to embodiments of the present disclosure, a method for controlling a robot hand includes causing a first member included in the robot hand to come into contact with an object to apply a gripping force to the object, and moving a second member included in the robot hand with respect to the first member to come into contact with the object.

Further features of the present disclosure will become apparent from the following description of exemplary embodiments with reference to the attached drawings.

### BRIEF DESCRIPTION OF THE DRAWINGS

FIG. 1 is a schematic view of a robot system according to a first embodiment.

FIG. 2 is a block diagram illustrating a structure of a control system in a robot system according to the first embodiment.

FIG. 3 is a perspective view of part of a robot hand according to the first embodiment.

FIG. 4A is an explanatory diagram of a manufacturing method including a control method according to the first embodiment.

FIG. 4B is an explanatory diagram of the manufacturing method including the control method according to the first embodiment.

FIG. 4C is an explanatory diagram of the manufacturing method including the control method according to the first embodiment.

FIG. 5A is an explanatory diagram of a manufacturing method including a control method according to a modification example of the first embodiment.

FIG. 5B is an explanatory diagram of the manufacturing method including the control method according to the modification example of the first embodiment.

FIG. 5C is an explanatory diagram of the manufacturing method including the control method according to the modification example of the first embodiment.

FIG. 6A is a schematic diagram for describing an operation of fingers of the robot hand according to the first embodiment.

FIG. 6B is a schematic diagram of a state in which the fingers of the robot hand according to the first embodiment are gripping a workpiece.

FIG. 6C is a schematic diagram of a state in which the fingers of the robot hand according to the first embodiment are gripping a workpiece.

FIG. 6D is a schematic diagram of a state in which the fingers of the robot hand according to the first embodiment are gripping a workpiece.

FIG. 6E is a schematic diagram of a state in which the fingers of the robot hand according to the first embodiment are gripping a workpiece.

FIG. 7 is a perspective view of part of the robot hand according to the first embodiment illustrating a configuration thereof.

FIG. 8 is a perspective view of part of the robot hand according to the first embodiment illustrating a configuration thereof.

FIG. 9A is an explanatory diagram of fingers and a driving mechanism included in a robot hand according to a second embodiment.

FIG. 9B is an explanatory diagram of the fingers and the driving mechanism included in the robot hand according to the second embodiment.

FIG. 10A is an explanatory diagram of fingers of a robot hand according to a third embodiment.

FIG. 10B is an explanatory diagram of the fingers of the robot hand according to the third embodiment.

FIG. 11A is an explanatory diagram of part of the robot hand according to the third embodiment.

FIG. 11B is an explanatory diagram of part of the robot hand according to the third embodiment.

FIG. 12A is an explanatory diagram of a manufacturing method including a control method according to a fourth embodiment.

FIG. 12B is an explanatory diagram of the manufacturing method including the control method according to the fourth embodiment.

FIG. 12C is an explanatory diagram of the manufacturing method including the control method according to the fourth embodiment.

FIG. 13A is an explanatory diagram of an assembly operation using a robot hand of a comparative example.

FIG. 13B is an explanatory diagram of the assembly operation using the robot hand of the comparative example.

### DESCRIPTION OF THE EMBODIMENTS

Most of parts of a product having a complicated structure are precision parts, and the shapes thereof vary in many ways. In the case where an object to be gripped by a robot hand is such a precise part, it is desired that the robot hand stably grips the object.

An object of the present disclosure is to cause a robot hand to stably grip an object.

Exemplary embodiments of the present disclosure will be described below in detail with reference to drawings.

### First Embodiment

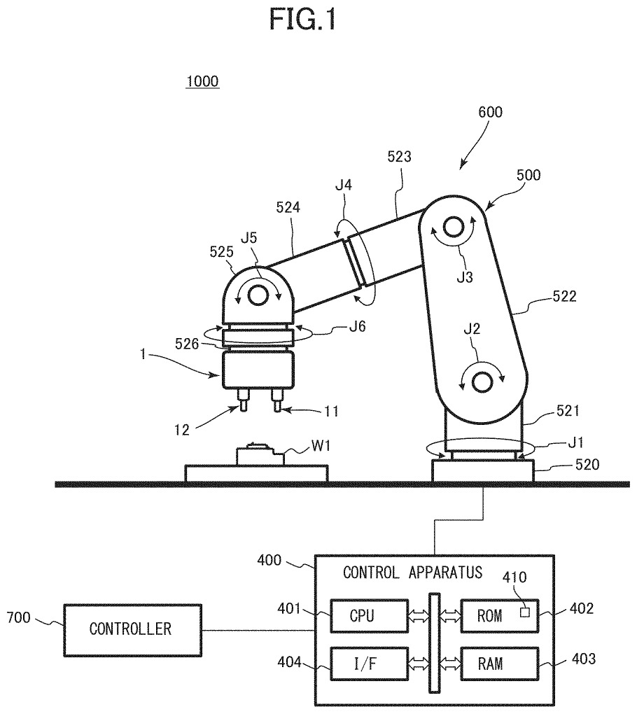

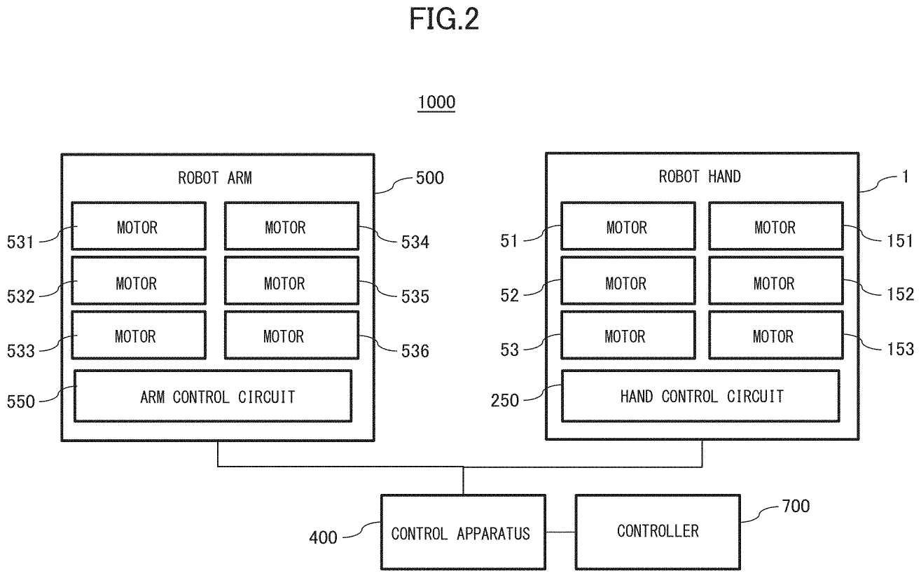

FIG. 1 is a schematic view of a robot system 1000 according to a first embodiment. FIG. 2 is a block diagram illustrating a structure of a control system in the robot system 1000 according to the first embodiment. In FIG. 1, the robot system 1000 includes a robot apparatus 600, and a control apparatus 400 that controls the robot apparatus 600. The control apparatus 400 is connectable to a controller 700. To be noted, in FIG. 1, the control apparatus 400 and the controller 700 are each illustrated as a block.

The controller 700 may be, for example, an operation device such as a teaching pendant, or another computer device capable of editing a robot program, such as a personal computer: PC or a server. The controller 700 is connectable to the control apparatus 400 via a wired or wireless communication connection portion, and has a user interface function for receiving operation on the robot apparatus 600 by a user, displaying the state of the robot apparatus 600, and the like.

The control apparatus 400 is constituted by a computer including a microprocessor and the like, and is capable of controlling the robot apparatus 600. As illustrated in FIG. 1, the computer constituting the control apparatus 400 includes a central processing unit: CPU 401, a read-only memory: ROM 402, a random access memory: RAM 403, a communication interface 404, and the like. The communication interface 404 will be hereinafter referred to as an I/F 404. The CPU 401 that is a processor serves as an example of a control portion.

The ROM 402 stores a program 410. The program 410 is a program for causing the computer, that is, the CPU 401 to execute a control method for the robot hand 1. The RAM 403 is used for temporarily storing data input from the controller 700 such as teaching data and control commands. The CPU 401 obtains the teaching data transmitted from the controller 700 by, for example, receiving the teaching data at the I/F 404. In addition, the CPU 401 can generate a trajectory of each shaft of the robot apparatus 600 on the basis of the teaching data, and transmit control commands as control target values to the robot apparatus 600 via the I/F 404.

To be noted, although the program 410 is stored in the ROM 402 in the first embodiment, the configuration is not limited to this. The program 410 may be stored in any recording medium as long as the recording medium is a non-transitory computer-readable recording medium. As the recording medium for supplying the program 410 to the computer, for example, flexible disks, hard disks, optical disks, magneto-photo disks, magnetic tapes, and nonvolatile memories can be used.

The robot apparatus 600 includes a robot arm 500, and a robot hand 1 disposed on the robot arm 500. The robot hand 1 is attached to a predetermined position on the robot arm 500, for example, to the distal end of the robot arm 500. The robot hand 1 is configured to be capable of gripping a workpiece W1 serving as a gripping target object.

The robot arm 500 is, for example, a vertically articulated robot arm. The robot arm 500 includes a link 520 serving as a base portion fixed to a workbench or surface plate, and a plurality of links 521 to 526 that transmit displacement and force. The plurality of links 520 to 526 are interconnected by a plurality of joints J1 to J6. As a result of this, the links 521 to 526 are pivotable or rotatable at the joints J1 to J6.

The robot atm 500 includes motors 531 to 536 that respectively drive the joints J1 to J6, that is, the links 521 to 526, and an arm control circuit 550 that controls the motors 531 to 536. The control apparatus 400 transmits a control command to the arm control circuit 550 on the basis of the teaching data. The arm control circuit 550 performs control such that the motors 531 to 536 each operate in accordance with a control command from the control apparatus 400. As described above, the control apparatus 400 is capable of transmitting a control command to the atm control circuit 550 to pivot or rotate each of the links 521 to 526. Therefore, the control apparatus 400 can move the robot hand 1 to a position and an orientation that are taught, in an operation space where the robot apparatus 600 is disposed.

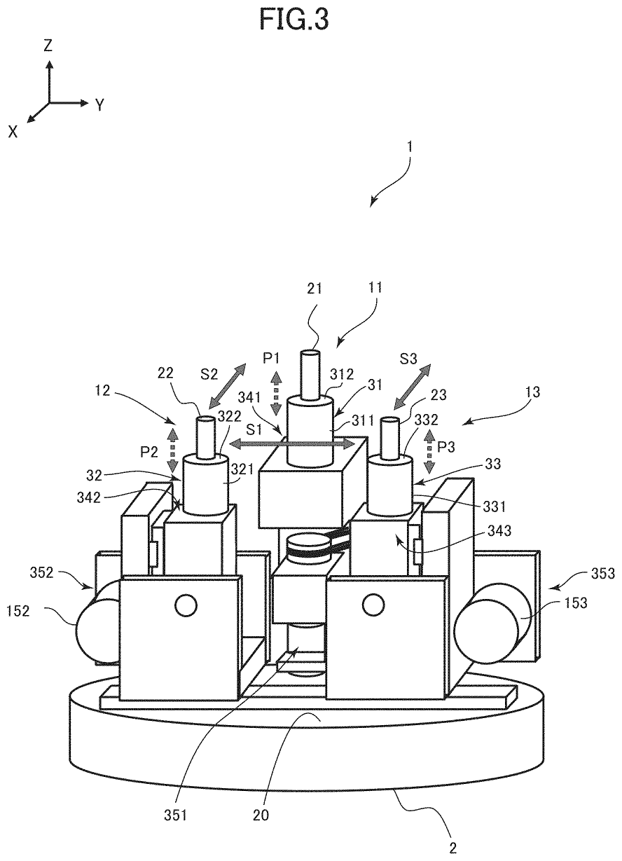

FIG. 3 is a perspective view of part of the robot hand 1 according to the first embodiment. In FIG. 3, illustration of the housing of the robot hand 1 is omitted. The robot hand 1 includes a hand base portion 2, and at least one finger supported by the hand base portion 2. In the first embodiment, the at least one finger is a plurality of fingers, and a case where the plurality of fingers are three fingers 11 to 13 will be described as an example. The finger 11 serves as an example of a first finger. The finger 12 serves as an example of a second finger. The finger 13 serves as an example of a third finger. The three fingers 11 to 13 can grip the workpiece W1 illustrated in FIG. 1.

The fingers 11 to 13 are disposed on a main surface 20 of the hand base portion 2. A direction perpendicular to the main surface 20 will be referred to as a Z direction, and two directions parallel to the main surface 20 and perpendicular to each other will be referred to as an X direction and a Y direction.

As illustrated in FIG. 2, the robot hand 1 includes a plurality of motors 51 to 53 and 151 to 153, and a hand control circuit 250 that controls the motors 51 to 53 and 151 to 153. The control apparatus 400 transmits a control command to the hand control circuit 250. The hand control circuit 250 performs control such that the motors 51 to 53 and 151 to 153 each operate in accordance with a control command from the control apparatus 400. The fingers 11 to 13 are each configured to be driven by corresponding ones of the motors 51 to 53 and 151 to 153 operating. As described above, the control apparatus 400 can cause the robot hand 1 to grip the workpiece W1 and release the grip by transmitting a control command to the hand control circuit 250.

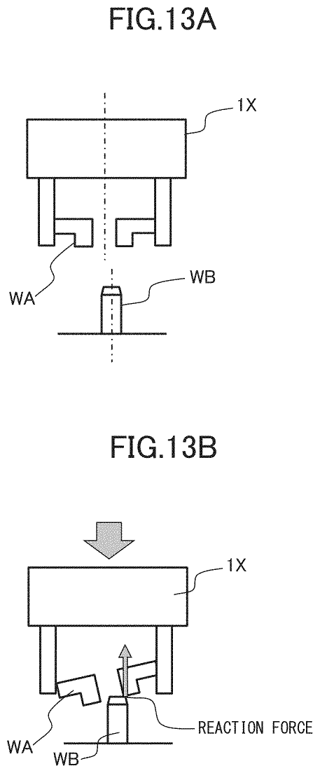

Here, an assembly operation using a robot hand of a comparative example will be described. FIGS. 13A and 13B are each an explanatory diagram of the assembly operation using a robot hand 1X of the comparative example. For example, an operation of coupling a gear part WA to a shaft WB will be described. An operation in which the robot hand 1X grips the gear part WA as illustrated in FIG. 13A and the gear part WA is fitted to the shaft WB as illustrated in FIG. 13B is performed. Generally, a fitting tolerance of the gear part WA and the shaft WB is strictly determined. It is difficult to bring the gear part WA into contact with the shaft WB by just position control of the robot arm. Therefore, a method in which a tapered portion is provided at an end portion of the shaft WB, and the shaft WB is fitted in the gear part WA by absorbing displacement of the shaft WB from the center by the mechanical compliance of the robot arm while bringing the gear part WA into contact with the shaft WB by using the tapered portion as a guide is employed. Alternatively, a method in which the robot arm includes a means for detecting a force, and the gear part WA is fitted to the shaft WB while controlling the force of the fingers of the robot arm such that the gear part WA is smoothly fitted to the shaft WB may be employed.

In either method, the reaction force of the contact between the gear part WA and the shaft WB is transmitted to the robot hand 1X. If the robot hand 1X cannot counter this reaction force, there is a possibility that the gear part WA is displaced from the robot hand 1X as illustrated in FIG. 13B and the assembly operation fails.

To counter this reaction force, cancelling the reaction force by a frictional force by increasing the gripping force of the robot hand 1X can be also considered. However, if the gripping force of the robot hand 1X is increased, the actuator of the robot hand 1X becomes larger, and thus the robot hand 1X also becomes larger. In addition, since the robot hand 1X grips the workpiece by a large gripping force, there is a possibility that the gripped workpiece deforms.

In the first embodiment, as illustrated in FIG. 3, the finger 11 includes a gripping member 21 serving as an example of a first member, and a slide member 31 that serves as an example of a second member and is movable with respect to the gripping member 21. In addition, the finger 12 includes a gripping member 22 serving as an example of a first member, and a slide member 32 that serves as an example of a second member and is movable with respect to the gripping member 22. In addition, the finger 13 includes a gripping member 23 serving as an example of a first member, and a slide member 33 that serves as an example of a second member and is movable with respect to the gripping member 23. The gripping members 21 to 23 are each a member capable of coming into contact with the workpiece W1 so as to apply a gripping force to the workpiece W1. The slide members 31 to 33 are each a member capable of coming into contact with the workpiece W1 gripped by the plurality of gripping members 21 to 23. The slide members 31 to 33 are movable with respect to the hand base portion 2 by respectively sliding with respect to the gripping members 21 to 23.

The slide member 31 can be positioned with respect to the gripping member 21. The slide member 32 can be positioned with respect to the gripping member 22. The slide member 33 can be positioned with respect to the gripping member 23. The plurality of slide members 31 to 33 are each independently movable.

The gripping member 21 is a shaft member extending in an axial direction P1 serving as a predetermined direction in the finger 11, and the slide member 31 is slidable in the axial direction P1 with respect to the gripping member 21. The gripping member 22 is a shaft member extending in an axial direction P2 serving as a predetermined direction in the finger 12, and the slide member 32 is slidable in the axial direction P2 with respect to the gripping member 22. The gripping member 23 is a shaft member extending in an axial direction P3 serving as a predetermined direction in the finger 13, and the slide member 33 is slidable in the axial direction P3 with respect to the gripping member 23. In the first embodiment, the axial directions P1 to P3 are parallel to each other. In addition, the axial directions P1 to P3 are parallel to the Z direction. Although the gripping members 21 to 23 may each have any shape, it is preferable that part of the gripping members 21 to 23 that can come into contact with the workpiece W1 has a columnar shape in consideration of making it possible to grip the workpiece W1 of any shape.

The slide member 31 includes a tubular portion 311 in which the gripping member 21 is inserted and which is capable of coming into contact with the workpiece W1 gripped by the plurality of gripping members 21 to 23. An end surface 312 of the tubular portion 311 in the axial direction P1 is capable of coming into contact with the workpiece W1 gripped by the plurality of gripping members 21 to 23. The slide member 32 includes a tubular portion 321 in which the gripping member 22 is inserted and which is capable of coming into contact with the workpiece W1 gripped by the plurality of gripping members 21 to 23. An end surface 322 of the tubular portion 321 in the axial direction P2 is capable of coming into contact with the workpiece W1 gripped by the plurality of gripping members 21 to 23. The slide member 33 includes a tubular portion 331 in which the gripping member 23 is inserted and which is capable of coming into contact with the workpiece W1 gripped by the plurality of gripping members 21 to 23. An end surface 332 of the tubular portion 331 in the axial direction P3 is capable of coming into contact with the workpiece W1 gripped by the plurality of gripping members 21 to 23. The tubular portions 311 to 331 respectively have through holes in which the gripping members 21 to 23 are inserted. The lengths of the tubular portions 311 to 331 in the Z direction are respectively smaller than the lengths of the gripping members 21 to 23 in the Z direction. As a result, the tubular portions 311 to 331 can respectively slide with respect to the gripping members 21 to 23.

The end surfaces 312, 322, and 332 are respectively distal end surfaces of the tubular portions 311, 321, and 331 in the axial directions P1, P2, and P3. Specifically, the end surfaces 312, 322, and 332 are each an end surface directed away from the main surface 20 of the hand base portion 2. The shape of the outer peripheral surface of each of the tubular portions 311, 321, and 331 may be any shape, and may be, for example, a circular shape or a polygonal shape as viewed in the axial direction.

The slide members 31 to 33 each can slide by being driven by a corresponding driving mechanism. That is, the robot hand 1 includes a driving mechanism 341 capable of driving the slide member 31 to slide the slide member 31 with respect to the gripping member 21. In addition, the robot hand 1 includes a driving mechanism 342 capable of driving the slide member 32 to slide the slide member 32 with respect to the gripping member 22. In addition, the robot hand 1 includes a driving mechanism 343 capable of driving the slide member 33 to slide the slide member 33 with respect to the gripping member 23. The driving mechanism 341 includes the motor 51 illustrated in FIG. 2. The driving mechanism 342 includes the motor 52 illustrated in FIG. 2. The driving mechanism 343 includes the motor 53 illustrated in FIG. 2. The motors 51 to 53 each serve as an example of a driving portion. In the first embodiment, the slide members 31 to 33 can be positioned at positions in contact with the workpiece W1 by being respectively driven by the driving mechanisms 341 to 343.

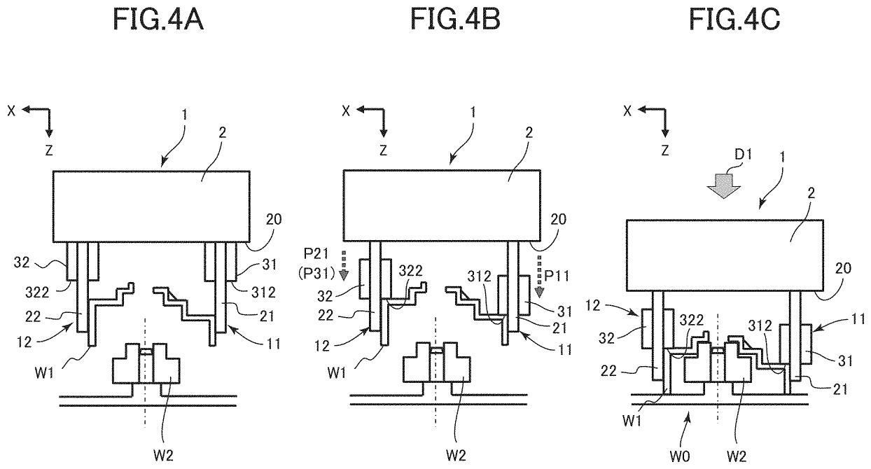

FIGS. 4A to 4C are explanatory diagrams of a manufacturing method for an assembled product W0 including a control method for the robot hand 1 according to the first embodiment. To be noted, in FIGS. 4A to 4C, since the finger 13 is at a position overlapping the finger 12, illustration of the finger 13 is omitted.

The workpiece W1 is a coupling member. By coupling the workpiece W1 to a workpiece W2 that is a coupled member, the assembled product W0 is manufactured. The assembled product W0 is an example of a product, and may be an intermediate product or a final product. To be noted, in the operation space, the robot hand 1 moves by operation of the robot arm 500.

First, in a step illustrated in FIG. 4A, the CPU 401 of the control apparatus 400 operates the motors 151 to 153 illustrated in FIG. 3 to cause the outer peripheral surface of each of the gripping members 21 to 23 of the robot hand 1 to come into contact with the workpiece W1 to apply a gripping force to the workpiece W1. As a result of this, the plurality of gripping members 21 to 23 grip the workpiece W1 by a predetermined gripping force.

Next, in a step illustrated in FIG. 4B, the CPU 401 of the control apparatus 400 operates the motors 51, 52 and 53 such that the slide members 31, 32, and 33 slides in abutting directions P11, P21, and P31 with respect to the gripping members 21, 22, and 23.

The abutting directions P11, P21, and P31 are respectively parallel to the axial directions P1, P2, and P3, and are each a direction to abut the workpiece W1 gripped by the gripping members 21, 22, and 23. According to this control, the slide members 31, 32, and 33 respectively move in the abutting directions P11, P21, and P31, and thus the end surfaces 312, 322, and 332 of the slide members 31, 32, and 33 come into contact with the workpiece W1. Specifically, the slide members 31 to 33 move in the abutting directions P11 to P31 that are directions perpendicular to the directions of the gripping force applied by the gripping members 21 to 23 and coincide with a direction D1 in which the workpiece W1 is coupled to the workpiece W2, and come into contact with the workpiece W1.

As described above, the slide members 31 to 33 respectively move along the axial directions P1 to P3 of the gripping members 21 to 23, abut the workpiece W1, and are thus positioned. As a result of this, the workpiece W1 is stably supported by the slide members 31 to 33. In addition, since the slide members 31 to 33 each independently slide, the slide members 31 to 33 can be each caused to abut the workpiece W1 in accordance with the shape of the workpiece W1.

Further, in a step illustrated in FIG. 4C, the CPU 401 of the control apparatus 400 controls the robot arm 500 such that the workpiece W1 gripped by the robot hand 1 is coupled to the workpiece W2, that is, such that the robot hand 1 moves in the coupling direction D1. As a result of this, the workpiece W1 is coupled to the workpiece W2, and thus the assembled product W0 is manufactured.

In this assembly operation, the workpiece W1 comes into contact with the workpiece W2, and thus receives an assembly reaction force from the workpiece W2. This reaction force is received by the slide members 31 to 33 supporting the workpiece W1. Therefore, displacement and slipping of the workpiece W1 with respect to the fingers 11 to 13 are reduced. That is, the robot hand 1 can stably grip the workpiece W1.

To be noted, it is also possible to cause the robot hand 1 to sequentially grip a plurality of workpieces W1 having the same shape. As a result of this, a plurality of assembled products W0 having the same shape can be sequentially manufactured. In the case of causing the robot hand 1 to grip the second or later workpiece W1, the slide members 31 to 33 may be positioned at positions to which the slide members 31 to 33 are positioned when the robot hand 1 is caused to grip the first workpiece W1 in the step illustrated in FIG. 4B. That is, when the robot hand 1 is caused to grip the second or later workpiece W1, the operation of moving the slide members 31 to 33 can be omitted. Even in the case where the plurality of workpieces to be sequentially gripped by the robot hand 1 have different shapes, the operation of moving the slide members 31 to 33 can be similarly omitted if at least portions to be gripped by the robot hand 1 have the same shape.

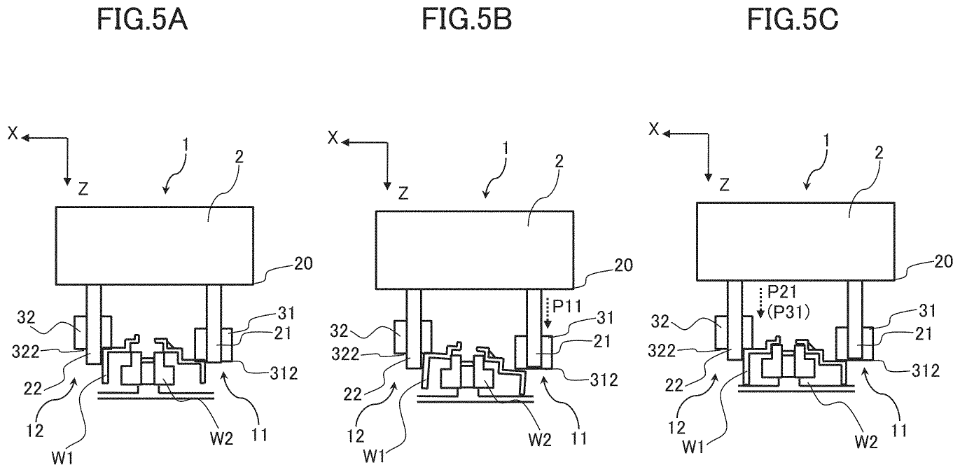

In addition, as illustrated in FIGS. 5A to 5C, the slide members 31 to 33 may be independently moved to couple the workpiece W1 to the workpiece W2. FIGS. 5A to 5C are explanatory diagrams of a manufacturing method of the assembled product W0 including a control method for the robot hand 1 according to a modification example of the first embodiment. To be noted, in FIGS. 5A to 5C, illustration of the finger 13 is omitted because the finger 13 is positioned to overlap the finger 12.

First, in the step illustrated in FIG. 5A, the CPU 401 of the control apparatus 400 operates the motors 151 to 153 illustrated in FIG. 3 to cause the outer peripheral surface of each of the gripping members 21 to 23 of the robot hand 1 to come into contact with the workpiece W1 to apply a gripping force to the workpiece W1. As a result of this, the plurality of gripping members 21 to 23 grip the workpiece W1 at a predetermined gripping force. Then, the gripped workpiece W1 is made closer to the workpiece W2 to a predetermined position.

Then, in the step illustrated in FIG. 5B, the CPU 401 of the control apparatus 400 operates the motor 51 such that the slide member 31 slides in the abutting directions P11 with respect to the gripping member 21. Further, the workpiece W1 is slightly elastically deformed withing the range of the rigidity of the workpiece W1 in which the workpiece W1 is not plastically deformed, and thus part of the workpiece W1 is brought into contact with part of the workpiece W2.

Then, in the step illustrated in FIG. 5C, the CPU 401 of the control apparatus 400 operates the motors 52 and 53 such that the slide members 32 and 33 slide in the abutting directions P21 and P31 with respect to the gripping members 22 and 23. As a result of this, the workpiece W1 is coupled to the workpiece W2, and thus the assembled product W0 is manufactured.

As described above, when coupling the workpiece W1 to the workpiece W2, the assembly may be performed such that the slide members 31, 32, and 33 are moved independently to bring part of the workpiece W1 into contact with the workpiece W2. As a result of this, in the case where more precise control is desired for assembly of the workpieces, this is preferable because the movement of the workpieces can be precisely controlled with the gripping members. In addition, in the case where the workpiece W1 to be gripped by the robot hand 1 has an irregular shape, part of the workpiece W1 gripped by the robot hand 1 is likely to be caught by part of the workpiece W2 different from an assembly target portion when coupling the workpiece W1 to the workpiece W2. Even in such a case, precise control such as pressing part of the workpiece W1 by independently moving one of the slide members 31, 32, and 33 can be executed.

To be noted, although the plurality of slide members 31 to 33 are independently moved in the assembly operation of coupling the workpiece W1 to the workpiece W2 in the example of FIGS. 5A to 5C, the configuration is not limited to this. The slide members 31, 32, and 33 may be moved in synchronization in the assembly operation.

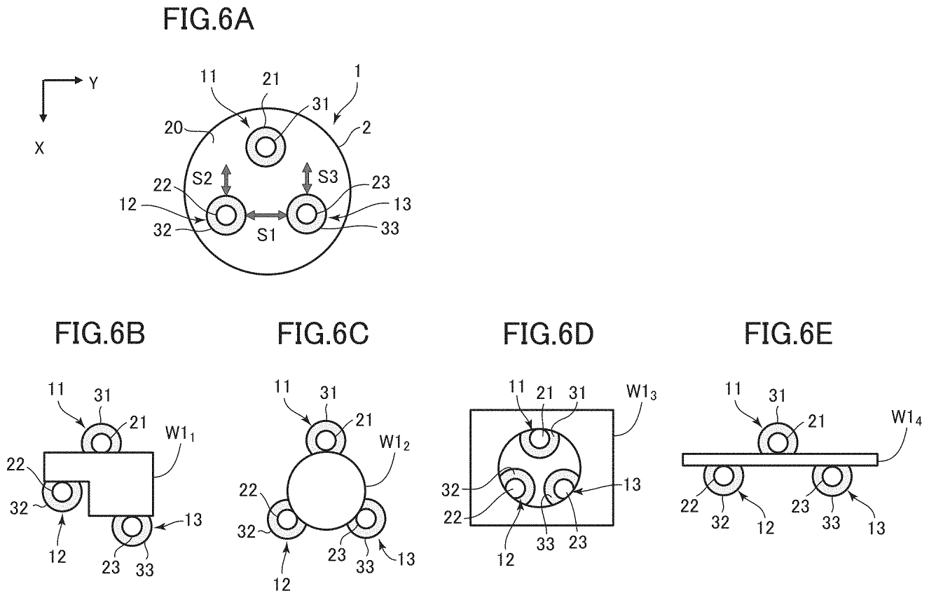

Next, the configuration of the robot hand 1 will be described in detail. FIG. 6A is a schematic diagram for describing the operation of the fingers 12 and 13 of the robot hand 1 illustrated in FIG. 3. The finger 11 is fixed to the hand base portion 2. The fingers 12 and 13 are disposed on the main surface 20 of the hand base portion 2 so as to be relatively movable with respect to the hand base portion 2 and the finger 11.

The fingers 12 and 13 are independently movable respectively in directions S2 and S3 in which the fingers 12 and 13 relatively move closer to and away from the finger 11. In addition, the fingers 12 and 13 are movable in a direction S1 in which the fingers 12 and 13 relatively move closer to and away from each other. The fingers 12 and 13 are movable in an interlocked manner in the direction in which the fingers 12 and 13 move closer to and away from each other. As described above, the finger 12 and 13 are relatively movable with respect to the hand base portion 2 and the finger 11, and the degree of freedom of the movement is 3 in total. For example, the directions S2 and S3 are parallel to the X direction, and the direction S1 is parallel to the Y direction. That is, the directions S2 and S3 are parallel to each other, and the direction S1 and the directions S2 and S3 are perpendicular to each other.

As described above, the robot hand 1 has the shape and degree of freedom described above, and thus can grip various workpieces W1₁ to W1₄ as gripping target objects as illustrated in FIGS. 6B to 6E. That is, the robot hand 1 can grip workpieces of various shapes such as the workpiece W1₁ having an irregular shape illustrated in FIG. 6B, the workpiece W12 having a cylindrical shape as illustrated in FIG. 6C, the workpiece W1₃ having a hole illustrated in FIG. 6D, and the workpiece W1₄ having a plate shape illustrated in FIG. 6E. Therefore, an operation of replacing the robot hand or the fingers of the robot hand each time the shape of the gripping target object changes can be reduced or eliminated, and thus the versatility of the robot hand 1 can be improved.

When causing the robot hand 1 to grip workpieces of various shapes, first, in the direction S1, the fingers 12 and 13 are separated from each other at positions corresponding to the size of the workpiece. Next, the fingers 12 and 13 are independently moved respectively in the directions S2 and S3 in accordance with the shape of the workpiece. As a result of this, the robot hand 1 can grip, for example, even the workpiece W1₁ having an irregular shape as illustrated in FIG. 6A. In addition, since the gripping members 21 to 23 have cylindrical shapes, the gripping members 21 to 23 can be brought into contact with the workpiece even in the case of a workpiece not having a flat surface perpendicular to the directions S2 and S3 or the direction S1. Therefore, the gripping members 21 to 23 can grip the workpieces W12 and W13 by bringing the gripping members 21 to 23 into contact with the outer peripheral surface of the workpiece W1₂ having a cylindrical shape illustrated in FIG. 6C and the inner peripheral surface of the hole of the workpiece W1₃ illustrated in FIG. 6D. In addition, also in the case of the workpiece W14 having a plate shape, the gripping members 21 to 23 can grip the workpiece W14 by bringing the gripping members 21 to 23 into contact with the workpiece W14.

As described above, the robot hand 1 includes the driving mechanism 341 capable of driving the slide member 31 of the finger 11, the driving mechanism 342 capable of driving the slide member 32 of the finger 12, and the driving mechanism 343 capable of driving the slide member 33 of the finger 13.

In addition, as illustrated in FIG. 3, the robot hand 1 includes a driving mechanism 352 capable of driving the finger 12 in the direction S2, a driving mechanism 353 capable of driving the finger 13 in the direction S3, and a driving mechanism 351 capable of driving the fingers 12 and 13 in an interlocked manner. The driving mechanism 351 includes the motor 151 illustrated in FIGS. 2 and 3, the driving mechanism 352 includes the motor 152 illustrated in FIGS. 2 and 3, and the driving mechanism 353 includes the motor 153 illustrated in FIGS. 2 and 3.

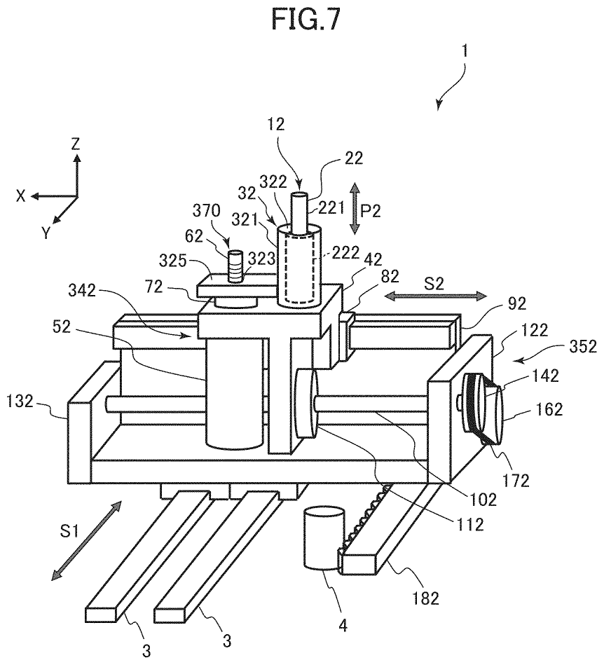

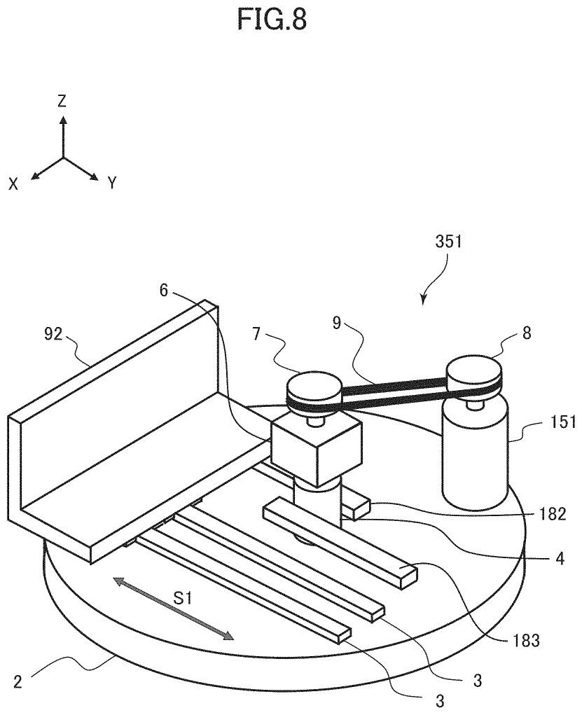

Focusing on the finger 12, the driving mechanisms 342, 351, and 352 will be described below. Since the driving mechanisms 341 and 343 have substantially the same configuration as the driving mechanism 342, description thereof will be omitted. In addition, since the driving mechanism 353 has substantially the same configuration as the driving mechanism 352, description thereof will be omitted. FIGS. 7 and 8 are each a perspective view of part of the robot hand 1 according to the first embodiment.

First, the driving mechanism 342 will be described. As illustrated in FIG. 7, the robot hand 1 includes the driving mechanism 342 capable of driving the slide member 32 such that the slide member 32 slides with respect to the gripping member 22. The finger 12 and the driving mechanism 342 are supported by a support member 42. The driving mechanism 342 includes the motor 52 described above, a screw member 62, and a holding member 72 that holds an unillustrated bearing.

Although the material of the gripping member 22 is not limited, the material is preferably stainless steel such as austenitic stainless steel containing phosphorous by 0.045% or less and sulfur by 0.030% or less (that is, stainless steel specified by SUS304 in Japanese Industrial Standards: JIS, in other words, stainless steel specified by S30400 in Unified Numbering System: UNS). The gripping member 22 is, for example, a stepped columnar part. The proximal end of the gripping member 22 is fixed to the support member 42. The gripping member 22 includes a small-diameter cylindrical portion 221, and a large-diameter cylindrical portion 222. In the gripping member 22, the small-diameter cylindrical portion 221 is positioned on the distal end side of the gripping member 22, and the large-diameter cylindrical portion 222 is positioned on the proximal end side of the gripping member 22. The small-diameter cylindrical portion 221 is capable of coming into contact with the workpiece W1. The large-diameter cylindrical portion 222 is in contact with the tubular portion 321 of the slide member 32. As a result of the gripping member 22 including the small-diameter cylindrical portion 221, the robot hand 1 can grip a small part.

The slide member 32 includes the tubular portion 321 described above, and a holding portion 325 holding the tubular portion 321. For example, the holding portion 325 includes a plate-shaped portion extending from the tubular portion 321 in a direction intersecting the axial direction P2. The holding portion 325 has a screw hole 323. The screw hole 323 is provided in a plate-shaped portion. Although the tubular portion 321 may be integrally formed with the holding portion 325, in the first embodiment, the tubular portion 321 is formed separately from the holding portion 325, and is fixed to the holding portion 325.

The tubular portion 321 of the slide member 32 is preferably a linear bush, but may be a member other than this as long as the member slides on the gripping member 22 with low friction, and examples thereof include an oilless bush and a member formed from a material such as polyacetal. The tubular portion 321 is disposed to cover part of the gripping member 22 and be slidable in the axial direction P2. The material of the part of the slide member 32 excluding the tubular portion 321, that is, the material of the holding portion 325 is not limited, and preferable examples thereof include copper such as phosphor bronze.

The motor 52 is fixed to the support member 42. The screw member 62 is coupled to the rotation shaft of the motor 52. The material of the screw member 62 is not limited, and preferable examples thereof include iron. The screw member 62 is rotatably supported by the support member 42 via an unillustrated bearing and the holding member 72. The screw member 62 is disposed to be screwed into the screw hole 323 of the slide member 32. That is, the screw member 62 is rotatably inserted into the screw hole 323. The screw hole 323 and the screw member 62 constitute a feed screw mechanism 370, and the rotational motion of the motor 52 is converted into a linear motion of the slide member 32.

That is, the motor 52 rotationally drives the screw member 62, and thus the screw member 62 rotates and transmits the drive to the slide member 32 via the screw hole 323 of the slide member 32. The slide member 32 is slidably coupled to the gripping member 22 in the tubular portion 321. Rotation of the slide member 32 with respect to the gripping member 22 is restricted, and the rotational motion of the screw member 62 becomes linear motion of sliding the slide member 32 in the axial direction P2 with respect to the gripping member 22.

To be noted, the small-diameter cylindrical portion 221 that comes into contact with the workpiece W1 in the gripping member 22 may include, for example, a base body such as metal and an elastic member such as rubber rolled around the base body to increase the contact area between the gripping member 22 and the workpiece W1. Also in this case, the small-diameter cylindrical portion 221 of the gripping member 22 including the elastic member needs to have a diameter smaller than the inner diameter of the tubular portion 321 of the slide member 32. In addition, the size of the gripping member 22 and the size of the tubular portion 321 may be appropriately set in accordance with the workpiece serving as a gripping target object.

The driving mechanism 342 that slides the slide member 32 with respect to the gripping member 22 preferably includes the feed screw mechanism 370 constituted by the screw member 62 and the screw hole 323 as a transmission mechanism for transmitting the drive. The feed screw mechanism 370 makes the slide member 32 less likely to back drive, and thus the slide member 32 can receive the assembly reaction force without the driving force of the motor 52.

To be noted, the slide member 32 may be manually movable with respect to the gripping member 22. For example, by omitting the motor 52 in FIG. 7, the user can rotationally operate the screw member 62. Further, by rotationally operating the screw member 62, the user can adjust the position of the slide member 32. In this case, the screw member 62 preferably has a head portion that the user can rotationally operate.

As described above, the slide member 32 can be positioned at a predetermined position with respect to the gripping member 22 via a transmission mechanism such as the feed screw mechanism 370 manually or by driving by the motor 52. By positioning the slide member 32 in advance, the robot hand 1 can be caused to sequentially grip a plurality of workpieces in the case where, for example, the plurality of workpieces have the same shape or parts of the plurality of workpieces that the robot hand 1 grips have the same shape.

Next, the driving mechanism 352 will be described. The driving mechanism 352 drives the finger 12, the driving mechanism 342, and the support member 42 in the direction S2. As illustrated in FIG. 7, the driving mechanism 352 includes a finger base portion 92 and a linear guide 82 that is provided on the support member 42 and coupled to the finger base portion 92 such that the support member 42 is linearly movable in the direction S2 with respect to the finger base portion 92. In addition, the driving mechanism 352 includes a ball screw 102 and a pair of holding portions 122 and 132 fixed to the finger base portion 92 with an interval therebetween in the direction S2.

The ball screw 102 includes a nut portion 112, and the nut portion 112 is coupled to the support member 42. Respective ends of the ball screw 102 in the direction S2 are shaft portions that are not threaded. The shaft portions of the ball screw 102 are respectively rotatably supported by the holding portions 122 and 132 via unillustrated bearings.

In addition, the driving mechanism 352 includes the motor 152 illustrated in FIG. 3. In addition, the driving mechanism 352 includes a pulley 162 that is a driving pulley coupled to the rotation shaft of the motor 152, and a pulley 142 that is a driven pulley coupled to one of the two shaft portions of the ball screw 102. In addition, the driving mechanism 352 includes an endless belt 172 looped over the pulleys 142 and 162. A motor body including the stator of the motor 152 is fixed to the holding portion 122. The pulleys 142 and 162 are coupled to each other via the belt 172. The pulleys 142 and 162 are each preferably a pulley with teeth. The belt 172 is preferably a belt with teeth that engage with each of the pulleys 142 and 162. The pulleys 142 and 162 preferably have the same number of teeth.

When the rotation shaft of the motor 152 rotates, the pulley 162 rotates, the drive thereof is transmitted to the pulley 142 via the belt 172, and thus the ball screw 102 rotates. Rotation of the support member 42 is restricted by the linear guide 82. Therefore, the rotational motion of the ball screw 102 is converted into a linear motion of the support member 42 in the direction S2 via the nut portion 112. The linear motion of the support member 42 becomes the opening/closing movement of the finger 12 with respect to the finger 11.

To be noted, although the drive transmission mechanism from the motor 152 to the ball screw 102 is preferably the configuration in which the belt 172 is looped over the pulleys 142 and 162 in consideration of the occupied space, the configuration is not limited to this. For example, a gear coupled to the rotation shaft of the motor 152 and a gear engaged with this gear and coupled to the ball screw 102 may be employed instead of the pulleys 142 and 162 and the belt 172. In addition, a coupling that couples the rotation shaft of the motor 152 to the ball screw 102 may be employed instead of the pulleys 142 and 162 and the belt 172.

Although the bearing provided on the holding portion 122 is preferably an angular ball bearing, and the bearing provided on the holding portion 132 is preferably a deep groove ball bearing, the configuration is not limited to this. In the case where a load on the ball screw 102 is only applied in the axial direction, the bearing provided on the holding portion 132 may be omitted.

Next, the driving mechanism 351 that moves the fingers 12 and 13 closer to and away from each other in the direction S1 will be described. The driving mechanism 351 is disposed in the hand base portion 2, and includes a linear guide 3 that linearly movably supports the finger base portion 92 supporting the finger 12 in the direction S1.

The rail of the linear guide 3 is shared by the fingers 12 and 13. An unillustrated finger base portion supporting the finger 13 is also linearly movably supported by the linear guide 3 in the direction S1 similarly to the finger 12.

In addition, the driving mechanism 351 includes the motor 151 described above. In addition, the driving mechanism 351 includes a pulley 8 that is a driving pulley coupled to the rotation shaft of the motor 151, a pulley 7 that is a driven pulley, and an endless belt 9 looped over the pulleys 7 and 8. In addition, the driving mechanism 351 includes a reduction gear 6 including an input shaft coupled to the pulley 7. In addition, the driving mechanism 351 includes a pinion gear 4 coupled to the output shaft of the reduction gear 6, and rack gears 182 and 183 engaged with the pinion gear 4.

In addition, the finger base portion 92 is fixed to the rack gear 182. The unillustrated finger base portion supporting the finger 13 is fixed to the rack gear 183. The reduction gear 6 is, for example, a strain wave reduction gear. The reduction gear 6 is fixed to the hand base portion 2 via an unillustrated support member. To be noted, the input shaft of the reduction gear 6 is rotatably supported with respect to the hand base portion 2 by an unillustrated bearing and an unillustrated holding member holding the bearing. The motor 151 is fixed to the hand base portion 2 via an unillustrated support member. The pulleys 7 and 8 preferably have the same number of teeth.

According to the configuration described above, when the rotation shaft of the motor 151 rotates, the pulley 8 rotates, the drive thereof is transmitted to the pulley 7 via the belt 9, and thus the input shaft of the reduction gear 6 rotates. The pinion gear 4 rotates at a rotational speed reduced by the reduction gear 6, and the rack gears 182 and 183 move in opposite directions in the direction S1. As a result of the rack gears 182 and 183 moving in the opposite directions, the fingers 12 and 13 linearly move in opposite directions in the direction S1 along the rail of the linear guide 3. As a result of this linear movement, the fingers 12 and 13 move closer to and away from each other.

To be noted, although the reduction gear 6 is preferably a strain wave reduction gear, the configuration is not limited to this. For example, the reduction gear 6 may be a planetary reduction gear or the like. In addition, although the drive transmission mechanism from the motor 151 to the reduction gear 6 is preferably the configuration in which the belt 9 is looped over the pulleys 7 and 8 in consideration of the occupied space, the configuration is not limited to this. For example, a gear coupled to the rotation shaft of the motor 151 and a gear engaged with this gear and coupled to the input shaft of the reduction gear 6 may be employed instead of the pulleys 7 and 8 and the belt 9. In addition, a coupling that couples the rotation shaft of the motor 151 to the input shaft of the reduction gear 6 may be employed instead of the pulleys 7 and 8 and the belt 9.

According to the mechanism described above, the robot hand 1 can stably grip workpieces of various shapes, and thus the assembly operation can be stably performed with the gripped workpieces.

As described above, according to the first embodiment, the workpiece W1 can be gripped by the gripping members 21 to 23 of the fingers 11 to 13 of the robot hand 1. Further, since the slide members 31 to 33 of the fingers 11 to 13 slide to abut the workpiece W1, the robot hand 1 can stably support a plurality of portions of the workpiece W1 in accordance with the shape of the workpiece W1 even if the workpiece W1 has a complicated shape. Therefore, the robot hand 1 can keep on stably gripping the workpiece W1 even if an assembly reaction force is generated. As a result of this, displacement or slip of the workpiece W1 with respect to the robot hand 1 in assembly of the assembled product W0 can be reduced, and the assembly operation can be stably performed, without excessively increasing the gripping force of the robot hand 1. In addition, since the robot hand 1 can grip workpieces W1 of various shapes, the versatility of the robot hand 1 is improved, and thus various assembly operations can be performed efficiently.

To be noted, although the finger 11 is fixed to the hand base portion 2 in the first embodiment, the configuration is not limited to this, and the finger 11 may be also configured to be relatively movable with respect to the hand base portion 2 similarly to the fingers 12 and 13.

In addition, although a case where the plurality of fingers 11 to 13 each include a slide member has been described in the first embodiment, the configuration is not limited to this. It suffices as long as at least one of the plurality of fingers has the configuration described above, and the plurality of fingers may include a finger having a configuration different from that described above. For example, the finger 11 may employ a fixed member that does not move with respect to the gripping member instead of the slide member 31, to reduce the degree of freedom.

### Second Embodiment

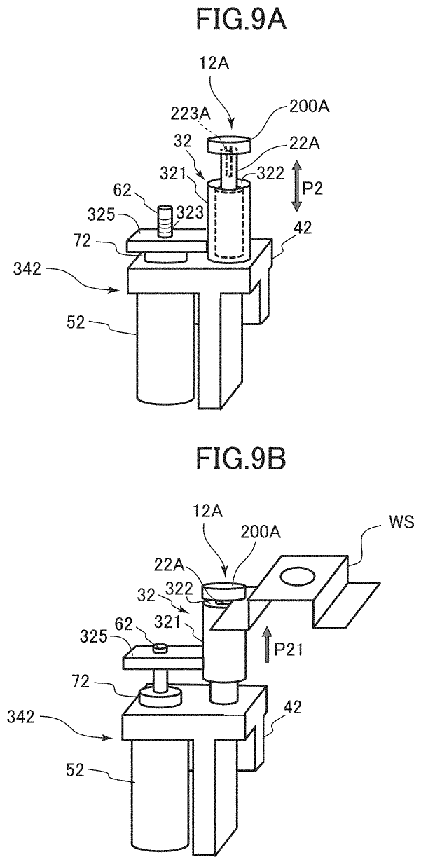

Next, a robot hand according to a second embodiment will be described. In the second embodiment, elements substantially the same as in the first embodiment will be denoted by the same reference signs, and description thereof will be omitted. The robot hand of the second embodiment includes a plurality of fingers. The configuration of the fingers of the robot hand of the second embodiment is different from the configuration of the fingers of the first embodiment. The elements other than the fingers of the robot hand of the second embodiment are the same as in the first embodiment. FIGS. 9A and 9B are each an explanatory diagram of a finger 12A and a driving mechanism 342 included in the robot hand according to the second embodiment. FIGS. 9A and 9B illustrate the one finger 12A among the plurality of fingers included in the robot hand of the second embodiment. To be noted, the other fingers than the finger 12A among the plurality of fingers each have substantially the same configuration as the finger 12A, and therefore description thereof will be omitted.

The finger 12A includes a gripping member 22A serving as an example of a first member, and the slide member 32 serving as an example of a second member. The robot hand of the second embodiment includes the driving mechanism 342 capable of driving the slide member 32. The configuration of the slide member 32 and the driving mechanism 342 is as described in the first embodiment.

In the second embodiment, the finger 12A includes an attachment member 200A that is detachably attached to the gripping member 22A and capable of coming into contact with a workpiece WS serving as a gripping target object. The attachment member 200A serves as an example of a third member. The slide member 32 and the attachment member 200A are capable of coming into contact with the workpiece WS such that the workpiece WS is interposed therebetween. The gripping member 22A is different from the gripping member 22 of the first embodiment in that the attachment member 200A is attachable thereto and detachable therefrom. The other elements of the gripping member 22A are the same as those of the gripping member 22.

The attachment member 200A is attachable to and detachable from an end surface 223A that is a distal end of the gripping member 22A in the axial direction P2. For example, the attachment member 200A includes a screw shaft, and a screw hole into which the screw shaft of the attachment member 200A is screwed is provided in the end surface 223A of the gripping member 22A. Part of the attachment member 200A other than the screw shaft is formed in a disk shape having a larger diameter than the gripping member 22A. The workpiece WS is, for example, a plate-shaped member such as a metal plate.

In this configuration of the finger 12A, as illustrated in FIG. 9B, the outer peripheral surface of the gripping member 22A is brought into contact with an end surface of the workpiece WS to apply the gripping force to the workpiece WS. To be noted, although illustration thereof is omitted, the other fingers than the finger 12A among the plurality of fingers also have substantially the same configuration as the finger 12A. By sliding the slide member 32 in the abutting direction P21, the workpiece WS positioned between the attachment member 200A and the slide member 32 can be gripped so as to be interposed between the attachment member 200A and the slide member 32 in the axial direction P2. As a result of this, the workpiece WS can be stably gripped by the robot hand of the second embodiment even in the case where the workpiece WS is a plate-shaped member such as a thin metal plate.

To be noted, although an example of the attachment member 200A has been described, an attachment member of a mechanism of a different embodiment may be disposed on the end surface 223A of the gripping member 22A. For example, the attachment member may be a cylindrical member having a smaller diameter than the end surface 223A of the gripping member 22A. This allows access to a narrow gap as is possible with tweezers. In addition, the gripping member 22A may be formed to have a hollow shape, and a suction attraction mechanism may be disposed at the end surface 223A. In addition, an approach sensor may be disposed at the end surface 223A. The wiring of the approach sensor may be provided through the hollow portion formed in the gripping member 22A. In addition, the second embodiment and modification examples thereof may be combined with the various embodiments described above and modification examples thereof.

### Third Embodiment

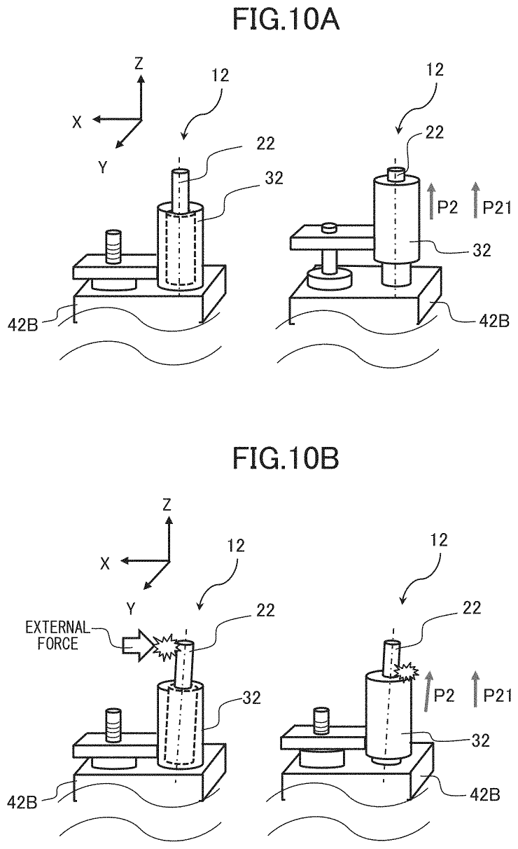

Next, a robot hand according to a third embodiment will be described. In the third embodiment, elements substantially the same as in the first embodiment will be denoted by the same reference signs, and description thereof will be omitted. The robot hand of the third embodiment includes a plurality of fingers. The configuration of the fingers of the robot hand of the third embodiment is substantially the same as the configuration of the fingers of the first embodiment. FIGS. 10A and 10B are explanatory diagrams of the finger 12 of the robot hand according to the third embodiment. The finger 12 is one of the plurality of fingers included in the robot hand of the third embodiment. Description will be given below focusing on the finger 12. In the third embodiment, the finger 12 and the driving mechanism 342 of FIG. 3 are supported by a support member 42B.

FIG. 10A illustrates a normal state of the gripping member 22, and FIG. 10B illustrates an abnormal state of the gripping member 22, for example, a state in which the gripping member 22 is tilted. FIGS. 10A and 10B illustrate part of the robot hand for the sake of convenience of description. As illustrated in FIG. 10A, the finger 12 includes the gripping member 22 and the slide member 32 similarly to the first embodiment. In the case where the axial direction P2 of the gripping member 22 and the abutting direction P21 of the slide member 32 are maintained parallel enough to move the slide member 32, the slide member 32 can be moved.

A case where something collides with the finger 12 during teaching or manufacture and an external force beyond the specifications, that is, an external force out of an allowable range is applied to the gripping member 22 as illustrated in FIG. 10B will be considered. In this case, it is possible that a supporting surface of the support member 42B supporting the gripping member 22 caves in and thus the gripping member 22 falls over, or the gripping member 22 itself is deformed. As a result of this, it is possible that the axial direction P2 of the gripping member 22 becomes no longer parallel to the abutting direction P21 of the slide member 32, and thus it becomes difficult or impossible for the slide member 32 to move with respect to the gripping member 22. Therefore, in the support member 42B of the robot hand of the third embodiment, further improvement of the maintainability of the finger 12 is attempted. The configuration of the support member 42B will be described in detail below.

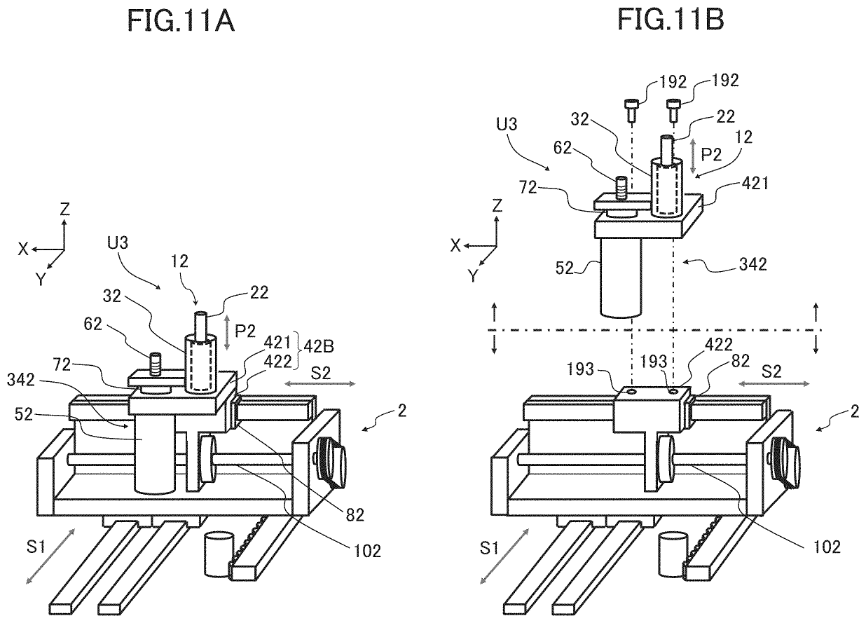

FIGS. 11A and 11B are explanatory diagrams of part of the robot hand according to the third embodiment. FIG. 11A illustrates a state in which the finger 12 is attached to the hand base portion 2, and FIG. 11B illustrates a state in which the finger 12 is detached from the hand base portion 2. The robot hand of the third embodiment includes the support member 42B supporting the finger 12 and the driving mechanism 342 instead of the support member 42 described in the first embodiment. The support member 42B includes a first support portion 421 and a second support portion 422. The first support portion 421 is detachably attached to the second support portion 422.

As illustrated in FIG. 11A, the first support portion 421 is provided with the finger 12 including the gripping member 22 and the slide member 32. Further, the first support portion 421 is also provided with the driving mechanism 342 including the motor 52, the screw member 62, and the holding member 72 for moving the slide member 32. As described above, the finger 12 and the driving mechanism 342 are supported by the first support portion 421. In the third embodiment, the first support portion 421 is provided as a unit with the finger 12 and the driving mechanism 342, and a unit U3 including the first support portion 421, the finger 12, and the driving mechanism 342 is detachably attached to the second support portion 422.

As illustrated in FIG. 11B, the second support portion 422 is provided on the linear guide 82. Further, the second support portion 422 has a screw hole 193 into which a screw member 192 is screwed. The first support portion 421 is configured to be attachable to and detachable from the second support portion 422 by fastening or releasing the screw member 192 in the axial direction P2 into and from the screw hole 193 of the second support portion 422.

As described above, the unit U3 including the gripping member 22, the slide member 32, the motor 52, the screw member 62, the holding member 72, the driving mechanism 342, and the first support portion 421 can be made attachable to and detachable from the second support portion 422. In other words, the unit U3 including the finger 12, the driving mechanism 342, and the first support portion 421 can be made attachable to and detachable from the hand base portion 2.

As described above, when an external force beyond the specifications of the gripping member 22, that is, an external force out of the allowable range of the gripping member 22 is applied to the gripping member 22, the gripping member 22 falls over, is deformed, or the like. In the third embodiment, since the support member 42B includes the first support portion 421 and the second support portion 422, the operation of detaching the finger 12 and the driving mechanism 342 from the hand base portion 2 and the operation of attaching the finger 12 and the driving mechanism 342 to the hand base portion 2 are easy. In addition, in the third embodiment, focusing on the point that the first support portion 421 can be treated as a replaceable part, the first support portion 421 is configured to be plastically deformed first among constituent parts of the robot hand when an external force beyond the specifications is applied to the gripping member 22. Specifically, the rigidity of the first support portion 421 is lower than the rigidity of the second support portion 422. As a result of this, even if a large external force is applied to the gripping member 22, since the first support portion 421 that is a replaceable part is plastically deformed first, an excessively large force can be prevented from being transmitted to constituent parts of the hand base portion 2 positioned more on the proximal end side of the robot hand than the first support portion 421.

In addition, the first support portion 421 that is a replaceable part is more likely to be deformed than the other constituent parts of the robot hand 1. As a result of this, the first support portion 421 is attachable to and detachable from the second support portion 422 while suppressing breakage of parts other than the replaceable part when something collides with the finger 12, and thus the replacing operation, that is, the maintenance operation becomes easier.

To be noted, although the first support portion 421 is configured to be more easily plastically deformed than the other parts, it is preferable that the first support portion 421 is not plastically deformed by a small external force. Therefore, as the material of the first support portion 421, stainless steel, for example, austenitic stainless steel containing phosphorous by 0.20% or less and sulfur by 0.15% or less (that is, stainless steel specified by SUS303 in JIS, in other words, stainless steel specified by S30300 in UNS) is preferable.

In addition, the finger 12 and the driving mechanism 342 being easily attachable to and detachable from the hand base portion 2 has other merits in addition to reduction of the time for the maintenance operation. For example, by preparing the finger 12 in which the length, the diameter, and/or the like of the gripping member 22 is changed and the driving mechanism 342 that drives the finger 12, a hand configuration corresponding to the demand of the user and the assembly process can be employed. In the case where a thin and long gripping member is suitable such as a case where a small part is coupled to a narrow space in the assembly process, a finger can be replaced by a finger including a thinner and longer gripping member than the gripping member 22 of a standard size.

Further, in a robot hand in which the user can rotationally operate the screw member 62, the motor 52 may be omitted from the driving mechanism 342. In this case, the motor and electric components related to the motor are not needed, and therefore the cost of the robot hand is reduced. As described above, by preparing fingers and driving mechanisms for various configurations as units in advance, a wider variety of assembly processes can be more versatilely handled.

According to the mechanism described above, the robot hand of the third embodiment can stably grip workpieces of various shapes and perform the assembly operation using the gripped workpieces, and further the maintainability can be also improved.

To be noted, although the finger 12 and the driving mechanism 342 have been described as an example in the third embodiment, the fingers 11 and 13 and the driving mechanisms 341 and 343 are also configured to be easily attachable to and detachable from the hand base portion 2 similarly to the finger 12 and the driving mechanism 342. In addition, although a case where the screw member 192 and the screw hole 193 are used for coupling between the first support portion 421 and the second support portion 422 has been described as an example, the configuration is not limited to this. For example, an attachable/detachable mechanism such as a notch pin or a snap-fit may be used for the coupling between the first support portion 421 and the second support portion 422. In addition, the various embodiments and modification examples described above may be combined with the present embodiment and or the present modification example.

### Fourth Embodiment

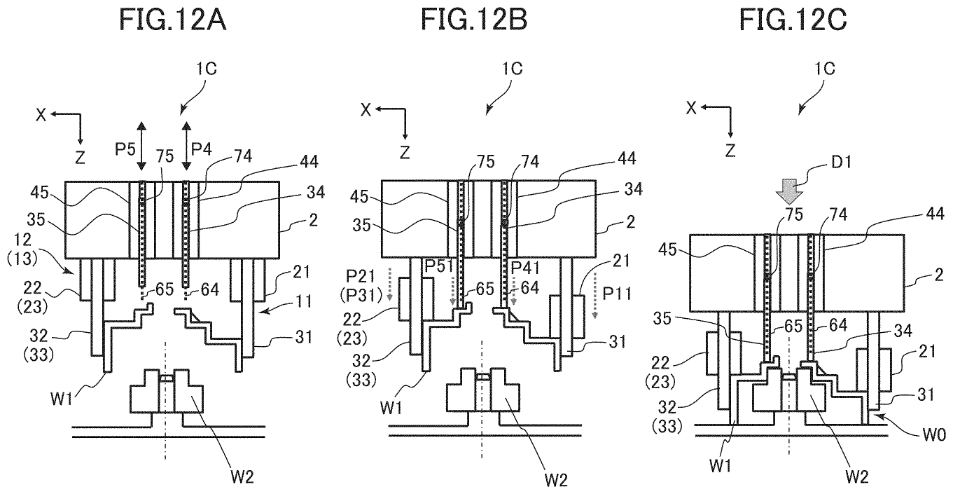

Next, a robot hand according to a fourth embodiment will be described. In the fourth embodiment, elements substantially the same as in the first embodiment will be denoted by the same reference signs, and description thereof will be omitted. FIGS. 12A to 12C are explanatory diagrams of a manufacturing method including a control method according to the fourth embodiment. A robot hand 1C of the fourth embodiment illustrated in FIGS. 12A to 12C includes the plurality of fingers 11 to 13 and the hand base portion 2 similarly to the first embodiment. To be noted, in FIGS. 12A to 12C, since the finger 13 is at a position hidden by the finger 12, illustration of the finger 13 is omitted. In addition, the robot hand 1C includes slide members 34 and 35 provided in the hand base portion 2 to be movable in the Z direction. The slide members 34 and 35 each serve as an example of a second member.

As illustrated in FIG. 12A, in the fourth embodiment, the slide member 34 is movable in a direction in which the slide member 34 projects from and retracts into the hand base portion 2, that is, in an axial direction P4. The slide member 35 is movable in a direction in which the slide member 35 projects from and retracts into the hand base portion 2, that is, in an axial direction P5. The axial directions P4 and P5 each serve as an example of a predetermined direction. The axial directions P4 and P5 are parallel to the Z direction. The slide members 34 and 35 are shaft members respectively extending in the axial directions P4 and P5. By moving the slide members 34 and 35 in the direction to project from the hand base portion 2, the distal ends of the slide members 34 and 35 in the Z direction can be brought into contact with the workpiece W1. The slide member 34 moves in a direction to abut the workpiece W1 along the screw member 64 provided in the hand base portion 2, that is, in the Z direction. The slide member 35 moves in a direction to abut the workpiece W1 along the screw member 65 provided in the hand base portion 2, that is, in the Z direction.

The slide members 34 and 35 are respectively provided with holding members 74 and 75. The holding members 74 and 75 are respectively coupled to screw members 64 and 65. Here, the screw members 64 and 65 are each, for example, a ball screw, and the holding members 74 and 75 are each, for example, a nut that moves in the Z direction by the rotation of the ball screw.

The slide members 34 and 35 are each a hollow member. The screw member 64 is disposed inside the slide member 34 so as not to be in contact with the inner wall of the slide member 34. In addition, the screw member 65 is disposed inside the slide member 35 so as not to be in contact with the inner wall of the slide member 35. The screw members 64 and 65 are each coupled to an unillustrated motor. Rotation of the holding member 74 and rotation of the holding member 75 are respectively restricted by rails 44 and 45.

When the rotation shaft of the motor coupled to the screw member 64 rotates, the screw member 64 rotates, and the slide member 34 linearly moves in the axial direction P4 via the holding member 74 whose rotation is restricted by the rail 44. In addition, when the rotation shaft of the motor coupled to the screw member 65 rotates, the screw member 65 rotates, and the slide member 35 linearly moves in the axial direction P5 via the holding member 75 whose rotation is restricted by the rail 45.

To be noted, although a case where the holding members 74 and 75 are used as a mechanism for linearly moving the slide members 34 and 35 has been described as an example in the fourth embodiment, the configuration is not limited to this. As a mechanism for linearly moving the slide member 34, for example, a configuration in which a screw head formed in part of the slide member 34 is engaged with the screw member 64 and the rotation of the slide member 34 is restricted by the rail 44 may be employed. In addition, as a mechanism for linearly moving the slide member 35, for example, a configuration in which a screw head formed in part of the slide member 35 is engaged with the screw member 65 and the rotation of the slide member 35 is restricted by the rail 45 may be employed. To be noted, although illustration thereof is omitted, the slide members 34 and 35, and the rails 44 and 45, the screw members 64 and 65, the holding members 74 and 75, and the unillustrated motors that drive the slide members 34 and 35 are provided at positions not interfering with the fingers 11 to 13 and mechanisms for moving the fingers 11 to 13.

Next, a manufacturing method for the assembled product W0 including the workpieces W1 and W2 will be described. First, in a step illustrated in FIG. 12A, the CPU 401 of the control apparatus 400 illustrated in FIG. 1 operates the motors 151 to 153 to cause the outer peripheral surface of each of the gripping members 21 to 23 of the robot hand 1C to come into contact with the workpiece W1 to apply a gripping force to the workpiece W1. As a result of this, the plurality of gripping members 21 to 23 grip the workpiece W1 by a predetermined gripping force.

Next, in a step illustrated in FIG. 12B, the CPU 401 of the control apparatus 400 operates the respective motors such that the slide members 31, 32, 33, 34, and 35 slide in respective abutting directions P11, P21, P31, P41, and P51.

The abutting directions P11 to P51 are respectively directions in which the slide members 31 to 35 abut the workpiece W1 gripped by the gripping members 21, 22, and 23. According to this control, the slide members 31 to 35 respectively move in the abutting directions P11 to P51. Then, the end surfaces of the slide members 31 to 35 each come into contact with the workpiece W1. Specifically, the slide members 31 to 35 move in the abutting directions P11 to P51 that are directions perpendicular to the directions of the gripping force applied by the gripping members 21 to 23 and coincide with the direction D1 in which the workpiece W1 is coupled to the workpiece W2, and come into contact with the workpiece W1.

As a result of the slide members 31 to 35 respectively moving to abut the workpiece W1 as described above, the workpiece W1 is stably supported by the slide members 31 to 35. In addition, since the slide members 31 to 35 each independently slide, the slide members 31 to 35 can be each caused to abut the workpiece W1 in accordance with the shape of the workpiece W1.

Next, in a step illustrated in FIG. 12C, the CPU 401 of the control apparatus 400 controls the robot arm 500 such that the workpiece W1 gripped by the robot hand 1C is coupled to the workpiece W2, that is, such that the robot hand 1C moves in the coupling direction D1. As a result of this, the workpiece W1 is coupled to the workpiece W2, and thus the assembled product W0 is manufactured.

In this assembly operation, the workpiece W1 comes into contact with the workpiece W2, and thus receives an assembly reaction force from the workpiece W2. This reaction force is received by the slide members 31 to 35 supporting the workpiece W1. Therefore, displacement and slipping of the workpiece W1 with respect to the fingers 11 to 13 are reduced. That is, the robot hand 1C can stably grip the workpiece W1.

As described above, according to the fourth embodiment, as a result of the robot hand 1C including the slide members 34 and 35 in addition to the fingers 11 to 13, flexible assembly can be more stably performed in accordance with the shape of the workpiece.

To be noted, although the slide members 31 to 35 are not moved with respect to the hand base portion 2 in the assembly illustrated in FIG. 12C in the fourth embodiment, the configuration is not limited to this. For example, as described with reference to FIG. 5, in the coupling of the workpiece W1, the slide members 31 to 35 may be independently moved to couple the workpiece W1 to the workpiece W2. In addition, in the coupling of the workpiece W1, the slide members 31 to 35 may be moved in synchronization to couple the workpiece W1 to the workpiece W2.

In addition, although a configuration in which the robot hand 1C includes all the slide members 31 to 35 has been described in the fourth embodiment, the configuration is not limited to this. For example, the slide members 31 to 33 may be omitted in the robot hand 1C. In addition, although a case where the linear movement of the slide members 34 and 35 according to the fourth embodiment is performed by a mechanism including a motor, a ball screw, and a nut has been described as an example, the configuration is not limited to this as long as the slide members 34 and 35 can be moved linearly. For example, the mechanisms that slide the slide members 34 and 35 may be each a link mechanism, or a driving mechanism utilizing a fluid pressure such as air pressure or hydraulic pressure.

The present disclosure is not limited to the embodiments described above, and embodiments can be modified in many ways within the technical concept of the present disclosure. In addition, the effects described in the embodiments are merely enumeration of the most preferable effects that can be obtained from embodiments of the present disclosure, and effects of embodiments of the present disclosure are not limited to those described in the embodiments.

Although a case where the robot arm is a vertically articulated robot arm has been described in the embodiments described above, the configuration is not limited to this. Examples of the robot arm include various robot arms such as horizontally articulated robot aims, parallel link robot aims, and orthogonal robots.

In addition, the embodiments described above are applicable to machines capable of automatically performing extension/contraction, bending/stretching, vertical movement, horizontal movement, turning, or a combined operation of these.

In addition, the disclosure of the present embodiments includes the following configurations and methods.

### Configuration 1

A robot hand including:

at least one finger,

wherein the finger includes
a first member configured to come into contact with an object to apply a gripping force to the object, and
a second member movable with respect to the first member to come into contact with the object.

### Configuration 2

The robot hand according to Configuration 1, wherein the second member is capable of being positioned with respect to the first member.

### Configuration 3

The robot hand according to Configuration 1 or 2,

wherein the first member is a shaft member extending in a predetermined direction, and

the second member is movable in the predetermined direction with respect to the first member.

### Configuration 4

The robot hand according to Configuration 3, wherein the second member includes a tubular portion in which the first member is inserted and which is capable of coming into contact with the object.

### Configuration 5

The robot hand according to Configuration 4, wherein an end surface of the tubular portion in the predetermined direction is capable of coming into contact with the object.

### Configuration 6

The robot hand according to any one of Configurations 1 to 5, wherein the second member further includes a driving mechanism capable of driving the second member such that the second member moves with respect to the first member.

### Configuration 7

The robot hand according to Configuration 6,

wherein the second member has a screw hole, and

wherein the driving mechanism includes a screw member configured to screw into the screw hole, and a driving portion configured to rotationally drive the screw member.

### Configuration 8

The robot hand according to Configuration 6 or 7, further including a support member configured to support the first member, the second member, and the driving mechanism.

### Configuration 9

The robot hand according to Configuration 8, wherein the support member includes a first support portion at which the first member, the second member, and the driving mechanism are provided, and a second support portion to which the first support portion is detachably attached.

### Configuration 10

The robot hand according to Configuration 9, wherein a rigidity of the first support portion is lower than a rigidity of the second support portion.

### Configuration 11

The robot hand according to any one of Configurations 1 to 5, wherein the second member is manually movable with respect to the first member.

### Configuration 12

The robot hand according to any one of Configurations 1 to 11, further including a third member detachably attached to the first member and capable of coming into contact with the object.

### Configuration 13

The robot hand according to Configuration 12, wherein the second member and the third member are capable of coming into contact with the object such that the object is interposed therebetween.

### Configuration 14

The robot hand according to any one of Configurations 1 to 13,

wherein the at least one finger includes a first finger and a second finger, and

wherein the first finger and the second finger each include the first member and the second member.

### Configuration 15

The robot hand according to Configuration 14, wherein the second member of the first finger and the second member of the second finger are movable independently from or in synchronization with each other to move the object gripped by the first member of the first finger and the first member of the second finger.

### Configuration 16

The robot hand according to any one of Configurations 1 to 13, further including a hand base portion,

wherein the at least one finger includes a first finger fixed to the hand base portion, and a second finger and a third finger that are movable with respect to the hand base portion, and

wherein the first finger, the second finger, and the third finger each include the first member and second member.

### Configuration 17

The robot hand according to Configuration 16, wherein the second finger and the third finger are respectively independently movable in directions in which the second finger and the third finger move closer to and away from the first finger.

### Configuration 18

The robot hand according to Configuration 16 or 17, wherein the second finger and the third finger are movable in a direction in which the second finger and the third finger move closer to and away from each other.

### Configuration 19

The robot hand according to Configuration 18, wherein the second finger and the third finger are movable in an interlocked manner with each other.

### Configuration 20

The robot hand according to any one of Configurations 1 to 3, further including a hand base portion,

wherein the second member is provided on the hand base portion so as to be movable with respect to the hand base portion to come into contact with the object.

### Configuration 21

A robot apparatus including:

the robot hand according to any one of Configurations 1 to 20; and

a robot arm in which the robot hand is disposed.

### Method 22

A method for manufacturing a product in which the product is manufactured by using the robot apparatus according to Configuration 21.

### Method 23

A method for controlling a robot hand, the method including:

causing a first member included in the robot hand to come into contact with an object to apply a gripping force to the object; and

moving a second member included in the robot hand with respect to the first member to come into contact with the object.

### Configuration 24

A program for causing a computer to execute the method according to Method 23.

### Configuration 25

Anon-transitory computer-readable recording medium storing the program according to Configuration 24.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-001524, filed Jan. 7, 2022, and Japanese Patent Application No. 2022-194600, filed Dec. 6, 2022, which are hereby incorporated by reference herein in their entirety.

What is claimed is:

1. A robot hand comprising:
at least one finger,
wherein the finger includes
a first member configured to come into contact with an object to apply a gripping force to the object, and
a second member movable with respect to the first member to come into contact with the object.

2. The robot hand according to claim 1, wherein the second member is capable of being positioned with respect to the first member.

3. The robot hand according to claim 1,
wherein the first member is a shaft member extending in a predetermined direction, and
the second member is movable in the predetermined direction with respect to the first member.

4. The robot hand according to claim 3, wherein the second member includes a tubular portion in which the first member is inserted and which is capable of coming into contact with the object.

5. The robot hand according to claim 4, wherein an end surface of the tubular portion in the predetermined direction is capable of coming into contact with the object.

6. The robot hand according to claim 1, wherein the second member further includes a driving mechanism capable of driving the second member such that the second member moves with respect to the first member.

7. The robot hand according to claim 6,
wherein the second member has a screw hole, and
wherein the driving mechanism includes a screw member configured to screw into the screw hole, and a driving portion configured to rotationally drive the screw member.

8. The robot hand according to claim 6, further comprising a support member configured to support the first member, the second member, and the driving mechanism.

9. The robot hand according to claim 8, wherein the support member includes a first support portion at which the first member, the second member, and the driving mechanism are provided, and a second support portion to which the first support portion is detachably attached.

10. The robot hand according to claim 9, wherein a rigidity of the first support portion is lower than a rigidity of the second support portion.

11. The robot hand according to claim 1, wherein the second member is manually movable with respect to the first member.

12. The robot hand according to claim 1, further comprising a third member detachably attached to the first member and capable of coming into contact with the object.

13. The robot hand according to claim 12, wherein the second member and the third member are capable of coming into contact with the object such that the object is interposed therebetween.

14. The robot hand according to claim 1,
wherein the at least one finger includes a first finger and a second finger, and
wherein the first finger and the second finger each include the first member and second member.

15. The robot hand according to claim 14, wherein the second member of the first finger and the second member of the second finger are movable independently from or in synchronization with each other to move the object gripped by the first member of the first finger and the first member of the second finger.

16. The robot hand according to claim 1, further comprising a hand base portion,
wherein the at least one finger includes a first finger fixed to the hand base portion, and a second finger and a third finger that are movable with respect to the hand base portion, and
wherein the first finger, the second finger, and the third finger each include the first member and second member.

17. The robot hand according to claim 16, wherein the second finger and the third finger are respectively independently movable in directions in which the second finger and the third finger move closer to and away from the first finger.

18. The robot hand according to claim 16, wherein the second finger and the third finger are movable in a direction in which the second finger and the third finger move closer to and away from each other.

19. The robot hand according to claim 18, wherein the second finger and the third finger are movable in an interlocked manner with each other.

20. The robot hand according to claim 1, further comprising a hand base portion,
wherein the second member is provided on the hand base portion so as to be movable with respect to the hand base portion to come into contact with the object.

21. A robot apparatus comprising:
the robot hand according to claim 1; and
a robot arm in which the robot hand is disposed.

22. A method for manufacturing a product in which the product is manufactured by using the robot apparatus according to claim 21.

23. A method for controlling a robot hand, the method comprising:
causing a first member included in the robot hand to come into contact with an object to apply a gripping force to the object; and
moving a second member included in the robot hand with respect to the first member to come into contact with the object.

24. Anon-transitory computer-readable recording medium storing a program for causing a computer to execute the method according to claim 23.
